(19) United States
(12) Patent Application Publication
(10) Pub. No.: US 2016/0158664 A1
(43) Pub. Date: Jun. 9, 2016

(54) MEDICAL TOY KIT AND STORAGE DEVICE

(71) Applicant: Kory Morris, Raeford, NC (US)

(72) Inventor: Kory Morris, Raeford, NC (US)

(21) Appl. No.: 14/561,420

(22) Filed: Dec. 5, 2014

(51) Int. Cl. A63H 33/30; G09B 23/28

(52) U.S. Cl. CPC A63H 33/3094; G09B 23/28

(57) ABSTRACT

A medical toy kit and storage device comprising a housing to contain a plurality of medical themed toys, where the housing is shaped as an ellipsoid; a lid atop the housing, where the lid is attached on a hinge; a pair of wheels at a bottom end of the housing; a handle attached to the housing opposite to the pair of wheels; and a set of lights positioned near the handle, where the set of lights flash to resemble an emergency vehicle. With the kit and storage device children are able to learn about medical instruments by being exposed to what they are and how they work.

### BACKGROUND OF THE INVENTION

1. Field of the Invention

The present invention relates to a novel toy chest within which toy medical supplies are stored.

2. Description of Related Art

Young children, within their early developmental years, are like sponges to absorb information. Exposing children to a wide variety of toys allows them to explore their interest and learn about many different subject matters. Many times having a toy kit allows the child to learn real life careers and scenarios. For example, a kitchen toy set includes fake foods, pots and pans, an oven, stove, sink and microwave to mimic cooking and cleaning in a home. Similarly, a cash register and checkout toy simulates checking out of a grocery store therefore teaching the child about the exchange of money for goods.

Similarly, kits are available to introduce features of a profession to the child. Professions like medicine, law enforcement, and science all have toy kits to allow the children to role play being doctors, police officers and scientists. These kits usually include common tools and equipment used by these professionals, like a stethoscope and forceps for a doctor, handcuffs and badge for the police officer, and a microscope and test tubes for a scientist. While all of these toys and kits are fun to play with and are educational for the children, they are also a hassle to clean. The box they are packed in is not meant for extended storage, so it typically becomes torn and tattered after a coupled uses. Also, toy boxes are large causing smaller pieces to get lost beneath larger toys. This is headache inducing when looking for a specific piece.

Therefore, it would be beneficial in the art to provide a toy storage container that is able to house a toy kit without being too large that the pieces get lost. It would also be desirable in the art to provide a toy storage box that is also educational to coordinate with the toy kit it is housing.

### SUMMARY OF THE INVENTION

In view of the foregoing disadvantages inherent in the prior art, the general purpose of the present invention is to provide a medical toy kit and storage device, configured to include all of the advantages of the prior art, and to overcome the drawbacks inherent therein.

Accordingly, an object of the present invention is to provide a medical toy kit and storage device to resemble a pill to reflect that toy medical tools are inside the housing.

Another object of the present invention is to provide a medical toy kit and storage device that is wheeled, has flashing lights and a siren similar to an emergency vehicle.

To achieve the above objects, in an aspect of the present invention, a medical toy kit and storage device is described comprising a housing to contain a plurality of medical themed toys, where the housing is shaped as an ellipsoid; a lid atop the housing, where the lid is attached on a hinge; a pair of wheels at a bottom end of the housing; a handle attached to the housing opposite to the pair of wheels; and a set of lights positioned near the handle, where the set of lights flash to resemble an emergency vehicle. With the kit and storage device children are able to learn about medical instruments by being exposed to what they are and how they work.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a medical toy kit and storage device in accordance with an exemplary embodiment of the present invention.

### DETAILED DESCRIPTION OF THE DRAWINGS

The present invention relates to a novel toy chest within which toy medical supplies are stored. The present invention provides a medical toy kit and storage device to introduce tools and instruments commonly used in the medical field to children. The medical toy kit and storage device includes a storage container that resembles a two-tone pill. The storage container opens with a lid to insert and remove a plurality of medical themed toys. With the medical toy kit and storage device children can play with the toy while also learning about various medical instruments.

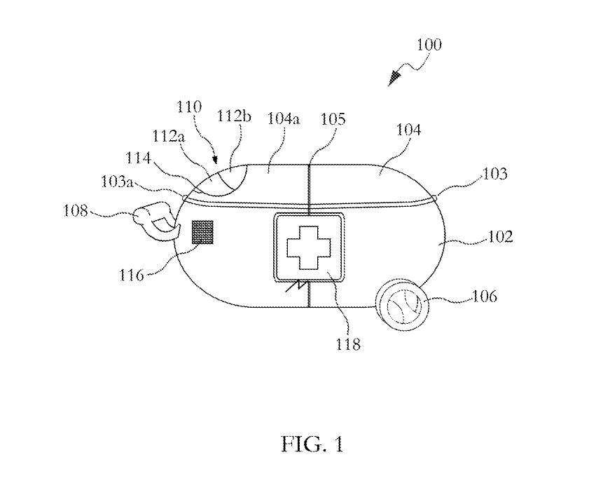

Turning now descriptively to the drawings, referring to FIG. 1, a perspective view of a medical toy kit and storage device 100 is shown in accordance with an exemplary embodiment of the present invention. The medical toy kit and storage device 100 includes a housing 102 or storage container. The housing 102 may be shaped like an ellipsoid to resemble a pill. The housing 102 may be colored a first color on one side of the ellipsoid and then colored a second color on the opposing side of a vertical midline 105. The color combinations may be red and white, blue and red, and the like which commonly exemplify a pill. The housing 102 is generally plastic to be lightweight and durable. A logo 116 may be positioned on a side of the housing 102. The logo 116 may be a round red cross, a caduceus, a rod of Asclepius or the like each reflecting the medical profession.

Attached to a top portion of the housing 102 may be a lid 104 connected to the housing on a hinge 103. The lid 104 may cover the entire top portion of the housing 102. Alternatively, the lid 104 may be partitioned into two portions 104, 104a each attached on hinges 103, 103a. The two portions of the lid 104, 104b meet at the midline to enclose the housing 102.

The housing 102 includes at least one set of wheels 106 to enable easy transport. The wheel 106 may be made from plastic or rubber. On an opposing side of the housing 102 from the wheel 106 may be a handle 108. The handle 108 is positioned opposite to the wheel 106 to allow the user to slightly elevate the front portion of the housing 102 and then easily transport the storage device 100 as needed. The handle 108 may be padded to ensure a comfortable grip against the user's hand.

Positioned above the handle 108 on the lid 104 may be a set of lights 110. The lights 110 may include a first light 112a, and a second light 112b to flash in an alternating fashion similar to an emergency vehicle. The lights 110 may be colored red, white, yellow or blue for a fun attention grabbing feature. Beneath the lights 110 may be an activation button 114 to initiate and stop the lights 110 from flashing. The housing 102 may further include a speaker 116 to make sounds like a siren. The speaker 116 may also be activated by the activation button 114 to allow the user to control when the housing 102 lights and sounds.

Within the housing 102 a plurality of toys may be received. The toys may include plastic scalpels, stethoscopes, tweezers, glasses, diagrams, microscopes, bandages, thermometer, syringe, scissors, otoscope, reflex hammer, sphygmomanometer, mirror, lab coat, scrubs and the like. An instruction booklet may be included to give a brief description of what each tool is, how it is used, and how it helps. With all of the toy instruments and instruction booklet the child and even adult users are able to explore the various tools of the medical field in a fun and entertaining way.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A medical toy kit and storage device comprising:
a. a housing to contain a plurality of medical themed toys, where the housing is shaped as an ellipsoid;
b. a lid atop the housing, where the lid is attached on a hinge;
c. a pair of wheels at a bottom end of the housing;
d. a handle attached to the housing opposite to the pair of wheels; and
e. a set of lights positioned near the handle, where the set of lights flash to resemble an emergency vehicle.

2. The medical toy kit and storage device according to claim 1, where the housing resembles a pill.

3. The medical toy kit and storage device according to claim 1, where the lid is separated into two pieces, where the two pieces are each attached on a hinge and meet at a vertical midline of the housing.

4. The medical toy kit and storage device according to claim 1, where the housing is colored on a first side of a vertical midline a first color and colored a second color on a second side of the vertical midline.

5. The medical toy kit and storage device according to claim 4, where the first color is white and the second color is red.

6. The medical toy kit and storage device according to claim 1, where the housing includes a speaker to sound an alarm.

7. The medical toy kit and storage device according to claim 1, where the set of lights include an activation button.

8. The medical toy kit and storage device according to claim 1, where the housing includes a logo.

9. The medical toy kit and storage device according to claim 1, where the plurality of medical themed toys include plastic scalpels, stethoscopes, tweezers, glasses, diagrams, microscopes, bandages, thermometer, syringe, scissors, otoscope, reflex hammer, sphygmomanometer, mirror, lab coat, and scrubs.

10. The medical toy kit and storage device according to claim 9, where the plurality of medical themed toys include an instruction booklet to explain each toy.
